(19) United States
(12) Patent Application Publication
(10) Pub. No.: US 2004/0160352 A1
(43) Pub. Date: Aug. 19, 2004

(54) Remote controller for keyless entry

(76) Inventors: Kazuhisa Shimizu, Kasugai-shi (JP); Shinji Hotta, Nagoya-shi (JP)

Correspondence Address: Jonathan P. Osha, OSHA & MAY L.L.P., Suite 2800, 1221 McKinney Street, Houston, TX, 77010, US

(21) Appl. No.: 10/758,685

(22) Filed: Jan. 15, 2004

(30) Foreign Application Priority Data
Jan. 22, 2003 (JP) 13620/2003

(51) Int. Cl. H04L 17/02; G08C 19/12; G08C 19/00

(52) U.S. Cl. 341/176; 340/825.72

(57) ABSTRACT

A remote controller for keyless entry according to the invention improves transmission power and avoids dielectric breakdown of an electronic circuit. The remote controller for keyless entry includes at least a case incorporating therein a transmission antenna and a transmission circuit and a conductive member (mechanical key) held at an end portion thereof by the cases and electrically insulated from the transmission circuit, wherein an entire outer surface or a part of an outer surface of the cases is formed into a conductive surface and the conductive surface and the conductive member are electrically connected. When the case is held by a hand, a fingertip and the conductive member (mechanical key) are electrically connected through the conductive surfaces of the outer surfaces of the cases and transmission power can be improved. Because the mechanical key and the internal antenna are not electrically connected, dielectric breakdown of an electronic circuit is not induced.

### BACKGROUND OF THE INVENTION

1. Field of the Invention

This invention relates to a remote controller for keyless entry.

2. Description of the Related Art

Locking and unlocking of doors of vehicles such as cars (hereinafter merely called “cars”) has for long been made by inserting a mechanical key into a keyhole of a door and rotating the key. However, a lock/unlock system of a wireless system using radio waves, infrared rays or ultrasonic waves (remote keyless entry system) has been mounted recently to the cars because the key operation is troublesome.

FIG. 5 of the accompanying drawings is a conceptual structural view of the remote keyless entry system. In the drawing, the remote keyless entry system 1 includes a remote controller 3 carried by a driver 2 and a receiver unit 5 mounted to a car 4. In the case of a remote keyless entry system using the radio waves, the remote controller 3 transmits identification information carried on the radio waves 6 when the driver pushes a push button (lock/unlock button) of the remote controller 3 in the proximity of the car 4. The receiver unit 5 receives the identification information, collates it with identification information held in advance in the receiver unit 5, judges the access as authentic from a correct remote controller 3 when they are coincident and locks or unlocks the door.

The Wireless Telegraph Act (Act No. 131, May 2, 1950) has been legislated in Japan to achieve effective utilization of radio waves. The remote controller for keyless entry using the radio waves corresponds to “Wireless Equipment” stipulated in Article 2, Item 2 of this Act and the remote controller for keyless entry and its operator corresponds to “Radio Station” stipulated in Article 2, Item 5. From a legal point of view, therefore, an application for opening the radio station must be filed pursuant to Article 4 of this Act but the remote keyless entry system can be used in accordance with the proviso (1) of Article 4 without getting a license of the Minister of Public Management, Home Affairs, Post and Telecommunication because transmission power of the remote controller for keyless entry is remarkably weak.

In other words, since the remote controller for keyless entry is supposed to use an extremely weak radio wave, it has the advantage of exemption of the provision of the Wireless Telegraph Act. On the other hand, the extremely weak radio wave has the disadvantage that a sufficient communication distance cannot be secured due to attenuation of the radio wave (because the intensity of the radio wave drops in inverse proportion to the fourth power of the distance). Various measures have therefore been taken to extend the communication distance.

### FIRST KNOWN EXAMPLE

For example, a patent reference 1, listed below, describes a technology in which a root of a mechanical key (that is called “key plate” in the patent reference) is unitarily fitted into a key grip and a transmission circuit unit assembled into the key grip and the mechanical key are connected so that the mechanical key can be used by itself as an antenna.

### SECOND KNOWN EXAMPLE

A patent reference 2 describes a technology in which a thin sheet-like conductor plate formed of an electrically conductive material is fitted to a front surface side of a casing of a remote controller for keyless entry and one of the ends of the conductor plate is connected to an antenna (internal antenna) inside the case so that the conductor plate can be used as an external antenna and the two antennas (internal antenna and external antennas) can be used.

Patent Reference 1:

JP-UM-A-5-35979

(paragraphs [0010] to [0016] and FIG. 1)

JP-A-7-221526

(paragraphs [0018] to [0026] and FIG. 1)

In both known examples cited above, however, the electronic circuit built in the accommodation member such as the key grip or the casing and the metal portion (key plate and conductor plate) outside the accommodation member are directly connected to each other. Therefore, when a human body comes into touch with such a metal portion, the charge built up in the human body operates as a surge current through the metal portion, flows into the electronic circuit and may invite dielectric breakdown of the electronic circuit.

Therefore, the inventors of this invention have conducted a series of wireless communication tests inside a sealed space (radio wave dark room) for inhibiting invasion of radio waves from outside and suppressing reflection of the radio waves from walls inside the sealed space. As a result, the inventors have found that transmission power can be improved (by about 10 dB) when a hand touches a mechanical key portion in a construction of a remote controller for keyless entry having only an internal antenna, that is, a construction in which the mechanical key and the internal antenna are not electrically connected (hereinafter called “specific construction”).

The invention aims at improving transmission power of a remote controller for keyless entry having the specific construction by utilizing the phenomenon described above, and at solving the problems of the prior art technologies by positively utilizing the merit of the remote controller for keyless entry having the specific construction (that is, the construction in which the mechanical key and the internal antenna are not electrically connected and which does not induce dielectric breakdown of an electronic circuit).

### SUMMARY OF THE INVENTION

In a remote controller for keyless entry including a case having at least a transmission antenna and a transmission circuit built therein and a conductive member held at an end portion thereof by the case and electrically insulated from the transmission circuit, one of the features of the remote controller for keyless entry according to the invention resides in that at least an entire outer surface or a part of an outer surface of the case is shaped into a conductive surface and the conductive surface and the conductive member are electrically connected to each other.

The “conductive member” held at the end portions thereof by the case may be a mechanical key or a conductive strap. When at least “a part of the outer surface” of the case is shaped into the conductive surface, “a part of the outer surface” must be the portion that comes into contact with a fingertip or fingertips when the case is held by a hand.

According to this construction, the fingertip and the conductive member (mechanical key or conductive strap) are electrically connected to each other through the conductive surface of the outer surface of the case when the case is held by the hand.

Therefore, this state (the state where the fingertip touches the conductive member) is equivalent to the state in the experiment inside the radio wave dark room described above, that is, the state where transmission power is improved when the hand touches the mechanical key portion. Transmission power of the remote controller for keyless entry having the specific construction (in which the mechanical key and the internal antenna are not electrically connected) can thus be improved and the problems of the prior art technologies can be solved by positively utilizing the merit of the remote controller for keyless entry having the specific construction (that does not invite dielectric breakdown of the electronic circuit because the mechanical key and the internal antenna are not electrically connected).

In a remote controller for keyless entry including a case having at least a transmission antenna and a transmission circuit built therein and push buttons fitted to an outer surface thereof, and a conductive member held at an end portion thereof by the case and electrically insulated from the transmission circuit, another feature of the remote controller for keyless entry according to the invention resides in that push buttons are arranged at positions such that when the push buttons are operated by a fingertip, the fingertip touches the conductive member.

According to this construction, the operating fingertip can touch the conductive member (mechanical key or conductive strap) when the push button is operated.

Therefore, this state (the state where the fingertip touches the conductive member), too, is equivalent to the state in the experiment inside the radio wave dark room described above, that is, the state where transmission power is improved when the hand touches the mechanical key portion. Transmission power of the remote controller for keyless entry having the specific construction (in which the mechanical key and the internal antenna are not electrically connected) can similarly be improved and the problems of the prior art technologies can be solved by positively utilizing the merit of the remote controller for keyless entry having the specific construction (that does not invite dielectric breakdown of the electronic circuit because the mechanical key and the internal antenna are not electrically connected).

The push button described above may be a push button for a remote engine start. Here, the term “push button for a remote engine start” means a remote-controlling button used for warming up an engine and a cold cabin in a cold district, for example, and for starting the engine from a remote place without the necessity for getting into the car.

The push button for the remote engine start is in common with the door lock/unlock button in that it transmits required information (identification information, engine start instruction signal, etc) from a remote place to a receiver unit inside the car but is different from the door lock/unlock button in the required communication distance. The remote engine start operation is made in most cases from inside a warm house particularly in the cold district because the distance to the parked car is great. Therefore, when the push button described above is the push button for the remote engine start, the communication distance can be extended only when the push button is pushed and the engine of the car at the remote place can be remote started.

### BRIEF DESCRIPTION OF THE DRAWINGS

FIG. 1 is a perspective view of a remote controller 10 for keyless entry and its exploded view;

FIG. 2 is a sectional view of the remote controller 10 for keyless entry;

FIG. 3 shows another embodiment of the invention;

FIG. 4 shows still another embodiment of the invention; and

FIG. 5 is a conceptual structural view of a remote keyless entry system.

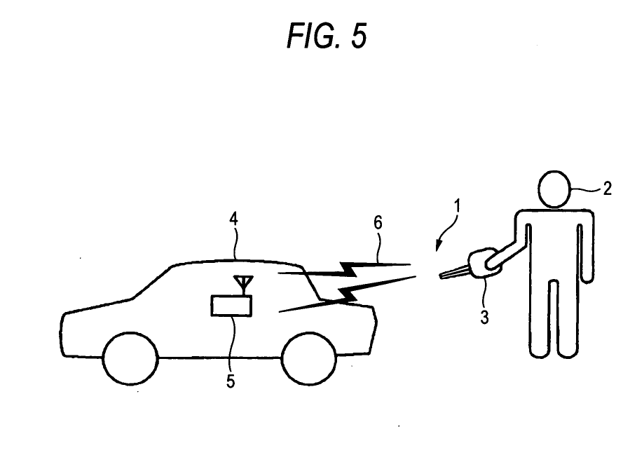

### DESCRIPTION OF THE PREFERRED EMBODIMENTS

Preferred embodiments of the invention will be explained hereinafter with reference to the accompanying drawings. Incidentally, it would be obvious to those skilled in the art that various stipulations of details, examples, numerical values, character strings and other signs appearing in the following explanation are merely for reference only to clarify the concept of the invention, and a part or the whole of them does not in any way limit the scope of the invention. Explanation in detail of known means, known procedures, known architectures, known circuit constructions and so forth (hereinafter called altogether “known matters”) will be avoided to simplify the explanation of the invention but the invention does not intentionally exclude a part or the whole of these known matters. Because those skilled in the art can know such known matters at the filing date of this application, they are naturally included in the following explanation.

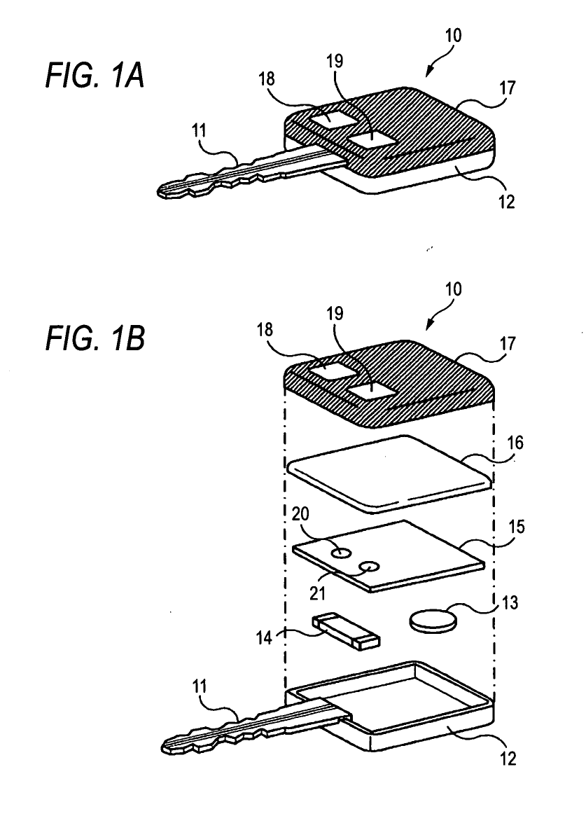

FIG. 1 is a perspective view of a remote controller 10 for keyless entry and its exploded view. Referring to the drawing, the remote controller 10 for keyless entry is assembled by fixing an end portion on the root side of a mechanical key 11 (corresponding to “conductor member” described in the scope of the invention) formed of a conductive material such as a metal to a lower case 12 by means such as screw fixing, adhesive or the like, and after a battery 13, an internal antenna 14 and a transmission circuit substrate 15 are mounted to the lower case 12, putting an upper case 17 on the lower case 12 while sandwiching a rubber-like insulating protective sheet 16 between them.

A door lock button 18 and a door unlock button 19 are provided to the upper case 17. A door lock switch 20 and a door unlock switch 21 corresponding respectively to these buttons 18 and 19 are provided to the transmission circuit substrate 15.

When a driver of the car pushes with his fingertip the door lock button 18 under the assembly state described above, the door lock switch 20 is pushed down and is turned ON through the insulating protective sheet 16 and a transmission current flows from a transmission circuit portion (not shown in the drawing) of the transmission circuit substrate 15 to the internal antenna 14. The internal antenna 14 transmits a radio wave carrying predetermined identification information and a lock instruction signal. When the driver pushes with his fingertip the door unlock button 19 under the similar state, the door unlock switch 21 is pushed down and is turned ON through the insulating protective sheet 16 and a transmission current flows from the transmission circuit portion (not shown) of the transmission circuit substrate 15 to the internal antenna 14 and the internal antenna 14 transmits a radio wave carrying predetermined identification information and an unlock instruction signal.

The structural features of this embodiment reside in that the upper case 17 is formed of the electrically conductive material (such as a metal) and that the upper case 17 and the mechanical key 11 are electrically connected to each other.

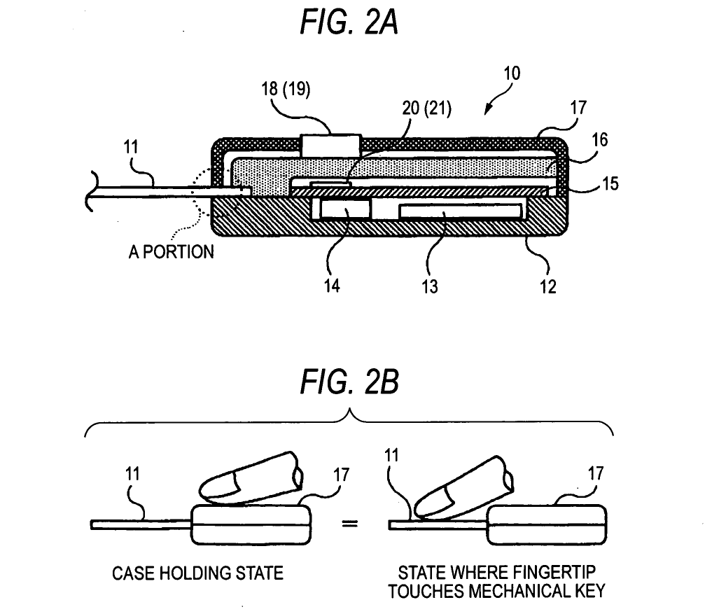

FIG. 2A is a sectional view of the remote controller 10 for keyless entry. As shown in the drawing, the battery 13, the internal antenna 14 and the transmission circuit substrate 15 are electrically insulated from the mechanical key 11 and the upper case 17 through the insulating protective sheet 16 but the mechanical key 11 and the upper case 17 keep electric contact with each other at an A portion, that is, at the root end portion of the mechanical key 11.

Consequently, this construction provides the following effects.

(1) Since the mechanical key 11 and the transmission circuit substrate 15 are electrically insulated from each other, the charge built up in the human body does not flow into the transmission circuit substrate 15 even when the human body comes into contact with the mechanical key 11. Consequently, dielectric breakdown of the transmission circuit substrate 15 can be avoided.

(2) The upper case 17 is formed of the electrically conductive material and is electrically connected to the mechanical key 11. Therefore, the state where the case (at least the upper case 17) is held by a hand (as shown by an image view on the left side of FIG. 2B) becomes equivalent to the state where the fingertip touches the mechanical key 11 (as shown by an image view on the right side of FIG. 2B). Under the state where at least the upper case 17 of the remote controller 10 for keyless entry is held by the hand in the embodiment, the phenomenon in which transmission power is improved develops in the same way as the result of the experiment of the radio wave dark room explained already. Consequently, the extension effect of the communication distance can be acquired even when the radio wave is extremely weak. Incidentally, the term “improvement of transmission power” does not mean the excess of power beyond the restriction of the Wireless Telegraph Act.

Though the upper case 17 is formed of the conductive material as a whole in this embodiment, the concept of the invention is not limited to the embodiment. In short, it is only necessary that the portion of the remote controller 10 for keyless entry that is gripped by the human body such as the fingertip (that is the outer surface of the upper case 17 or lower case 12) has conductivity and this conductive portion is electrically connected to only the mechanical key 11. For example, it is possible to form a part of the upper case 17 from the electrically conductive material (by two-color molding, for example) or to cover the outer surface of the upper case 17 and the lower case 12 with a conductive film. Alternatively, a part of the outer surface with which the hand or the fingertip comes into contact may be covered with the conductive film. These “part of the upper case 17” and “part of the outer surface of the case” correspond to “a part of the outer surface” described in the scope of the invention.

Still alternatively, it is possible to wind a conductive belt 22 along the bonding boundary between the upper case 17 and the lower case 12 and to connect the conductive belt 22 and the mechanical key 11. In this instance, the conductive belt 22 corresponds to “a part of the outer surface of the case” described in the scope of the invention.

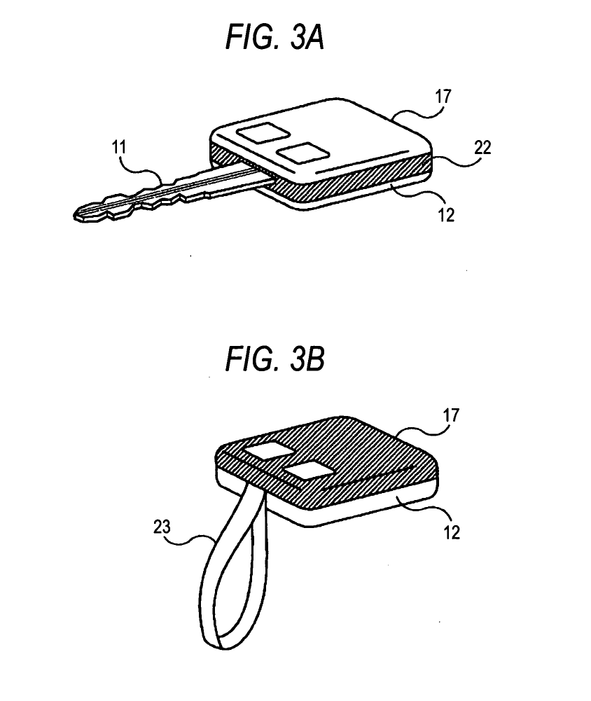

It is further possible to fit a conductive strap 23 having a suitable design in place of the mechanical key 11 shown in FIG. 3A and to electrically connect the conductive strip 23 to the upper case 17 or to the conductive belt 22. In this instance, the conductive strap 23 corresponds to the “conductive member” described in the scope of the invention.

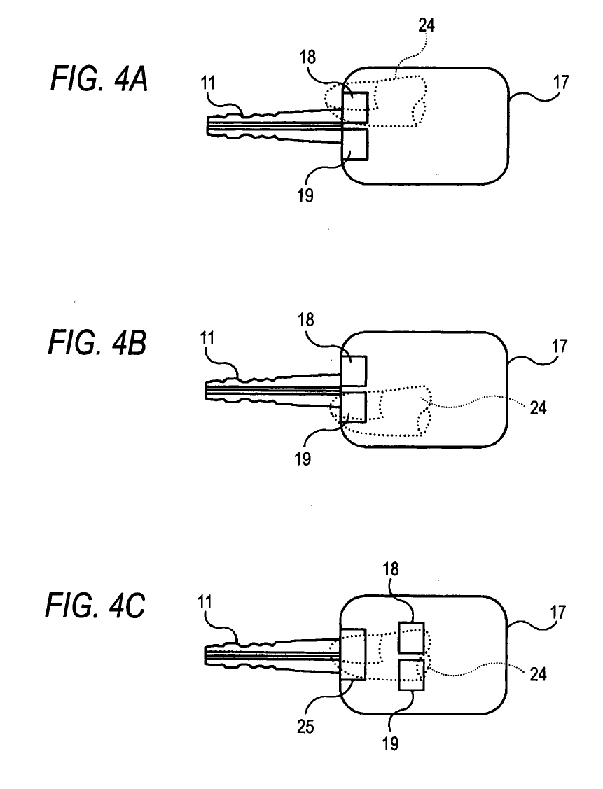

Alternatively, the push buttons 18 and 19 may be arranged at suitable positions as shown in FIGS. 4A and 4B so that when these push buttons 18 and 19 are touched by a fingertip 24, the fingertip 24 can always touch the mechanical key 11. For example, the push buttons 18 and 19 may be positioned as close as possible to the mechanical key 11. In such a case, the fingertip 24 can touch without fail the mechanical key 11 when the push buttons 18 and 19 are operated, and the upper case 17 need not be formed of the conductive material. In consequence, the afore-mentioned effect (2), that is, the improvement in transmission power in the same way as the experimental result of the radio wave dark room, develops without inviting the increase of the cost and the extension effect of the communication distance can be acquired even when the radio wave is remarkably weak.

Incidentally, the push buttons 18 and 19 are respectively the door lock push button and the door unlock push button. Because these push buttons 18 and 19 are operated near the door to lock or unlock the door, the practical communication distance may sufficiently be several meters. An excessive communication distance is not desirable because the door of other car might be locked or unlocked accidentally in a large parking lot and is not desirable from the aspect of security, either.

On the other hand, some remote controllers for remote keyless entry include a push button for remote engine start in addition to the push button 18 for door locking and the push button 19 for door unlocking. The communication distance of this remote engine start must be considerably longer than that of the remote controller for locking and unlocking the door because the engine of a car at a remote place must be started smoothly. Since the communication distance required for locking and unlocking the door is different from the communication distance required for remote starting the engine, it is desirable to extend the communication distance only when the push button for the remote engine start is operated in the remote controller for remote keyless entry having the push button for the remote engine start.

FIG. 4C is a preferred layout view of the remote controller for remote keyless entry having the push button for the remote engine start. In this embodiment, the door lock button 18 and the door unlock button 19 are arranged near the center of the upper case 17 and the push button 25 for the remote engine start is arranged at a position as close as possible to the mechanical key 11. According to this example, the fingertip 24 can be brought into touch with the mechanical key 11 only when the push button 25 for the remote engine start is operated and the communication distance can be extended. When the push buttons 18 and 19 for locking and unlocking the door are operated, the fingertip 24 is inhibited from touching the mechanical key 11 and the communication distance of only the internal antenna 14 can be extended limitedly. Therefore, the different required communication distances for locking and unlocking the door and for remote starting the engine can be simultaneously accomplished.

According to the invention, the fingertip and the conductive member (mechanical key or conductive strap) are electrically connected to each other through the conductive surface of the outer surface of the case.

Therefore, this state (where the fingertip keeps touch) is the state equivalent to the afore-mentioned experiment in the radio wave dark room, that is, “the state inducing the phenomenon in which the improvement of transmission power develops when the hand touches the mechanical key portion”. Transmission power of the remote controller for keyless entry having the specific construction (where the mechanical key and the internal antenna are not electrically connected) can thus be improved and the problems of the prior art technologies described above can be eliminated by positively utilizing the merit of the remote controller for keyless entry having this construction (that is, the merit that dielectric breakdown of the electronic circuit does not occur because the mechanical key and the internal antenna are not electrically connected).

According to another embodiment, the operating fingertip can touch the conductive member (mechanical key or conductive strap) during the operation of the push buttons.

Therefore, this state (fingertip touch state) is equivalent to the state of the experiment in the radio wave dark room, that is, “the state inducing the phenomenon in which the improvement of transmission power develops when the hand touches the mechanical key portion”. Transmission power of the remote controller for keyless entry having the specific construction (where the mechanical key and the internal antenna are not electrically connected) can thus be improved, too, and the problems of the prior art technologies described above can be eliminated by positively utilizing the merit of the remote controller for keyless entry having this construction (that is, the merit that dielectric breakdown of the electronic circuit does not occur because the mechanical key and the internal antenna are not electrically connected).

Incidentally, the push button described above may be used as the push button for the remote engine start. When this push button is pushed, the communication distance can be extended and the engine of the car at a far place can be remote started.

What is claimed is:

1. A remote controller for keyless entry including a case having at least a transmission antenna and a transmission circuit built therein and a conductive member held at an end portion thereof by said case and electrically insulated from said transmission circuit, wherein at least an entire outer surface or a part of an outer surface of said case is formed into a conductive surface and said conductive surface and said conductive member are electrically connected to each other.

2. A remote controller for keyless entry according to claim 1, wherein a part of said outer surface is a portion touched by a fingertip when the case is held by a hand.

3. A remote controller for keyless entry including a case having at least a transmission antenna and a transmission circuit built therein and push buttons fitted to an outer surface thereof, and a conductive member held at an end portion thereof by said case and electrically insulated from said transmission circuit, wherein said push buttons are arranged at positions such that when said push buttons are operated by a fingertip, said fingertip touches said conductive member.

4. A remote controller for keyless entry according to claim 3, wherein said push button is a push button for a remote engine start.

5. A remote controller for keyless entry according to claims 1 or 3, wherein said conductive member is a mechanical key or a conductive strap.
